(19) United States
(12) Patent Application Publication
(10) Pub. No.: US 2021/0158795 A1
(43) Pub. Date: May 27, 2021

(54) GENERATING AUDIO FOR A PLAIN TEXT DOCUMENT

(71) Applicant: MICROSOFT TECHNOLOGY LICENSING, LLC, Redmond, WA (US)

(72) Inventors: Wei LIU, Redmond, WA (US); Min ZENG, Redmond, WA (US); Chao ZOU, Redmond, WA (US)

(73) Assignee: Microsoft Technology Licensing, LLC, Redmond, WA (US)

(21) Appl. No.: 17/044,254

(22) PCT Filed: Apr. 30, 2019
(86) PCT No.: PCT/US2019/029761

§ 371 Date: Sep. 30, 2020

(30) Foreign Application Priority Data
May 10, 2018 (CN) 201810441748.3

(51) Int. Cl. G10L 13/08; G10L 15/18; G10L 25/63

(52) U.S. Cl. CPC G10L 13/08; G10L 2013/083; G10L 25/63; G10L 15/1815

(57) ABSTRACT

The present disclosure provides method and apparatus for generating audio for a plain text document. At least a first utterance may be detected from the document. Context information of the first utterance may be determined from the document. A first role corresponding to the first utterance may be determined from the context information of the first utterance. Attributes of the first role may be determined. A voice model corresponding to the first role may be selected based at least on the attributes of the first role. Voice corresponding to the first utterance may be generated through the voice model.

### BACKGROUND

A plain text document may be transformed to audio through utilizing techniques, e.g., text analysis, voice synthesis, etc. For example, corresponding audio simulating people's voices may be generated based on a plain text document, so as to present content of the plain text document in a form of voice.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose a method and apparatus for generating audio for a plain text document. At least a first utterance may be detected from the document. Context information of the first utterance may be determined from the document. A first role corresponding to the first utterance may be determined from the context information of the first utterance. Attributes of the first role may be determined. A voice model corresponding to the first role may be selected based at least on the attributes of the first role. Voice corresponding to the first utterance may be generated through the voice model.

Embodiments of the present disclosure propose a method and apparatus for providing an audio file based on a plain text document. The document may be obtained. At least one utterance and at least one descriptive part may be detected from the document. For each utterance in the at least one utterance, a role corresponding to the utterance may be determined, and voice corresponding to the utterance may be generated through a voice model corresponding to the role. Voice corresponding to the at least one descriptive part may be generated. The audio file may be provided based on voice corresponding to the at least one utterance and the voice corresponding to the at least one descriptive part.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for generating an audio file based on a plain text document according to an embodiment.

FIG. 2 illustrates an exemplary process for determining a role corresponding to an utterance according to an embodiment.

FIG. 3 illustrates another exemplary process for determining a role corresponding to an utterance according to an embodiment.

FIG. 4 illustrates an exemplary process for generating voice corresponding to an utterance according to an embodiment.

FIG. 5 illustrates an exemplary process for generating voice corresponding to a descriptive part according to an embodiment.

FIG. 6 illustrates an exemplary process for determining background music according to an embodiment.

FIG. 7 illustrates another exemplary process for determining background music according to an embodiment.

FIG. 8 illustrates an exemplary process for determining a sound effect according to an embodiment.

FIG. 9 illustrates a flowchart of an exemplary method for providing an audio file based on a plain text document according to an embodiment.

FIG. 10 illustrates a flowchart of an exemplary method for generating audio for a plain text document according to an embodiment.

FIG. 11 illustrates an exemplary apparatus for providing an audio file based on a plain text document according to an embodiment.

FIG. 12 illustrates an exemplary apparatus for generating audio for a plain text document according to an embodiment.

FIG. 13 illustrates an exemplary apparatus for generating audio for a plain text document according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Transformation of plain text documents to audio may facilitate to improve readability of the plaint text documents, enhance usage experiences of users, etc. In terms of document format, plain text documents may comprise any formats of documents including plain text, e.g., editable document, web page, mail, etc. In terms of text content, plain text documents may be classified into a plurality of types, e.g., story, scientific document, news report, product introduction, etc. Herein, plain text documents of the story type may generally refer to plain text documents describing stories or events and involving one or more roles, e.g., novel, biography, etc. With audio books being more and more popular, the need of transforming plain text documents of the story type to corresponding audio increases gradually. Up to now, there is a plurality of approaches for transforming plain text documents of the story type to corresponding audio. In an approach, the TTS (text-to-speech) technique may be adopted, which may generate corresponding audio based on a plain text document of the story type through voice synthesis, etc., so as to tell content of the plain text document in a form of voice. This approach merely generates audio for the whole plain text document in a single tone, but could not discriminate different roles in the plain text document or use different tones for different roles respectively. In another approach, different tones may be manually set for different roles in a plain text document of the story type, and then voices may be generated, through, e.g., the TTS technique, for utterances of a role based on a tone specific to this role. This approach needs to make manual settings for tones of different roles.

Embodiments of the present disclosure propose automatically generating an audio file based on a plain text document, wherein, in the audio file, different tones are adopted for utterances from different roles. The audio file may comprise voices corresponding to descriptive parts in the plain text document, wherein the descriptive parts may refer to sentences in the document that are not utterances, e.g., asides, etc. Moreover, the audio file may also comprise background music and sound effects. Although the following discussions of the embodiments of the present disclosure aims at plain text documents of the story type, it should be appreciated that the inventive concepts of the present disclosure may be applied to plain text documents of any other types in a similar way.

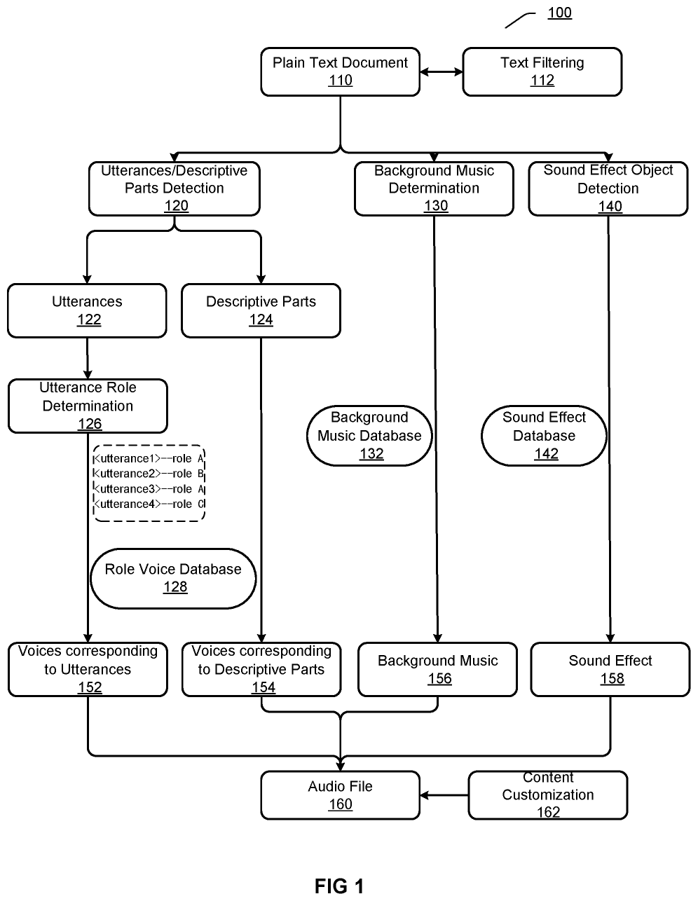

FIG. 1 illustrates an exemplary process 100 for generating an audio file based on a plain text document according to an embodiment. Various operations involved in the process 100 may be automatically performed, thus achieving automatic generation of an audio file from a plain text document. The process 100 may be implemented in an independent software or application. For example, the software or application may have a user interface for interacting with users. The process 100 may be implemented in a hardware device running the software or application. For example, the hardware device may be designed for only performing the process 100, or not merely performing the process 100. The process 100 may be invoked or implemented in a third party application as a component. As an example, the third application may be, e.g., an artificial intelligence (AI) chatbot, wherein the process 100 may enable the chatbot to have a function of generating an audio file based on a plain text document.

At 110, a plain text document may be obtained. The document may be, e.g., a plain text document of the story type. The document may be received from a user through a user interface, may be automatically obtained from the network based on a request from a user or a recognized request, etc.

In an implementation, before processing the obtained document to generate an audio file, the process 100 may optionally comprise performing text filtering on the document at 112. The text filtering intends to identify words or sentences not complying with laws, government regulations, moral rules, etc., from the document, e.g., expressions involving violence, pornography, gambling, etc. For example, the text filtering may be performed based on word matching, sentence matching, etc. The words or sentences identified through the text filtering may be removed, replaced, etc.

At 120, utterances and descriptive parts may be detected from the obtained document. Herein, an utterance may refer to a sentence spoken by a role in the document, and a descriptive part may refer to sentences other than utterances in the document, which may also be referred to as aside, etc. For example, for a sentence <Tom said “It's beautiful here”>, “beautiful” is an utterance, and “Tom said” is a descriptive part.

In an implementation, the utterances and the descriptive parts may be detected from the document based on key words. A key word may be a word capable of indicating occurrence of utterance, e.g., “say”, “shout”, “whisper”, etc. For example, if a key word “say” is detected from a sentence in the document, the part following this key word in the sentence may be determined as an utterance, while other parts of the sentence are determined as descriptive parts.

In an implementation, the utterances and the descriptive parts may be detected from the document based on key punctuations. A key punctuation may be punctuation capable of indicating occurrence of utterance, e.g., double quotation marks, colon, etc. For example, if double quotation marks are detected in a sentence of the document, the part inside the double quotation marks in the sentence may be determined as an utterance, while other parts of the sentence are determined as descriptive parts.

In an implementation, for a sentence in the document, this sentence may be determined as a descriptive part based on a fact that no key word or key punctuation is detected.

The detecting operation at 120 is not limited to any one above approach or combinations thereof, but may detect the utterances and the descriptive parts from the documents through any appropriate approaches. Through the detecting at 120, one or more utterances 122 and one or more descriptive parts 124 may be determined from the document.

For the utterances 122, a role corresponding to each utterance may be determined at 126 respectively. For example, assuming that the utterances 122 comprise <utterance 1>, <utterance 2>, <utterance 3>, <utterance 4>, etc., it may be respectively determined that the utterance 1 is spoken by a role A, the utterance 2 is spoken by a role B, the utterance 3 is spoken by the role A, the utterance 4 is spoken by a role C, etc. It will be discussed later in details about how to determine a role corresponding to each utterance.

After determining a role corresponding to each utterance in the utterances 122, voice 152 corresponding to each utterance may be obtained. A corresponding voice model may be selected for each role, and the voice model corresponding to the role may be used for generating voice for utterances of this role. Herein, a voice model may refer to a voice generating system capable of generating voices in a specific tone based on text. A voice model may be used for generating voice of a specific figure or role. Different voice models may generate voices in different tones, and thus may simulate voices of different figures or roles.

In an implementation, a role voice database 128 may be established previously. The role voice database 128 may comprise a plurality of candidate voice models corresponding to a plurality of different figures or roles respectively. For example, roles and corresponding candidate voice models in the role voice database 128 may be established previously according to large-scale voice materials, audiovisual materials, etc.

The process 100 may select, from the plurality of candidate voice models in the role voice database 128, a voice model having similar role attributes based on attributes of the role determined at 126. For example, for the role A determined at 126 for <utterance 1>, if attributes of the role A are similar with attributes of a role A′ in the role voice database 128, a candidate voice model of the role A′ in the role voice database 128 may be selected as the voice model of the role A. Accordingly, this voice model may be used for generating voice of <utterance 1>. Moreover, this voice model may be further used for generating voices for other utterances of the role A.

Through the similar approach, a voice model may be selected for each role determined at 126, and voices may be generated for utterances of the role with the voice model corresponding to the role. It will be discussed later in details about how to generate voice corresponding to an utterance.

For the descriptive parts 124, voices 154 corresponding to the descriptive parts 124 may be obtained. For example, a voice model may be selected from the role voice database 128, for generating voices for the descriptive parts in the document.

In an implementation, the process 100 may comprise determining background music for the obtained document or one or more parts of the document at 130. The background music may be added according to text content, so as to enhance attraction of the audio generated for the plain text document. For example, a background music database 132 comprising various types of background music may be established previously, and background music 156 may be selected from the background music database 132 based on text content.

In an implementation, the process 100 may comprise detect sound effect objects from the obtained document at 140. A sound effect object may refer to a word in a document that is suitable for adding sound effect, e.g., an onomatopoetic word, a scenario word, an action word, etc. Through adding sound effects at or near positions where sound effect objects occur in the document, vitality of the generated audio may be enhanced. For example, a sound effect database 142 comprising a plurality of sound effects may be established previously, and sound effects 158 may be selected from the sound effect database 142 based on detected sound effect objects.

According to the process 100, an audio file 160 may be formed based on the voices 152 corresponding to the utterances, the voices 154 corresponding to the descriptive parts, and optionally the background music 156 and the sound effects 158. The audio file 160 is an audio representation of the plain text document. The audio file 160 may adopt any audio formats, e.g., way, mp3, etc.

In an implementation, the process 100 may optionally comprise performing content customization at 162. The content customization may add voices, which are based on specific content, to the audio file 160. The specific content may be content that is provided by users, content providers, advertisers, etc., and not recited in the plain text document, e.g., personalized utterances of users, program introduction, advertises, etc. The voices which are based on the specific content may be added to the beginning, the end or any other positions of the audio file 160.

In an implementation, although not shown in the figure, the process 100 may optionally comprise performing a pronunciation correction process. In some types of language, e.g., in Chinese, the same character may have different pronunciations in different application scenarios, i.e., this character is a polyphone. Thus, in order to make the generated audio have correct pronunciations, pronunciation correction may be performed on the voices 152 corresponding to the utterances and the voices 154 corresponding to the descriptive parts. For example, a pronunciation correction database may be established previously, which comprises a plurality of polyphones having different pronunciations, and correct pronunciations of each polyphone in different application scenarios. If the utterances 122 or the descriptive parts 124 comprise a polyphone, a correct pronunciation may be selected for this polyphone through the pronunciation correction database based on the application scenario of this polyphone, thus updating the voices 152 corresponding to the utterances and the voices 154 corresponding to the descriptive parts.

It should be appreciated that the process 100 of FIG. 1 is an example of generating an audio file based on a plain text document, and according to specific application requirements and design constraints, various appropriate variants may also be applied to the process 100. For example, although FIG. 1 shows generating or determining the voices 152 corresponding to the utterances, the voices 154 corresponding to the descriptive parts, the background music 156 and the sound effects 158 respectively, and then combining them into the audio file 160, the audio file 160 may also be generated directly through adopting a structural audio labeling approach, rather than firstly generating the voices 152 corresponding to the utterances, the voices 154 corresponding to the descriptive parts, the background music 156 and the sound effects 158 respectively.

The structural audio labeling approach may generate a structural audio labeled text based on, e.g., Speech Synthesis Markup Language (SSML), etc. In an implementation, in the structural audio labeled text, for each utterance in the document, this utterance may be labeled by a voice model corresponding to a role speaking this utterance, and for each descriptive part in the document, this descriptive part may be labeled by a voice model selected for all descriptive parts. In the structural audio labeled text, background music selected for the document or for one or more parts of the document may also be labeled. Moreover, in the structural audio labeled text, a sound effect selected for a detected sound effect object may be labeled at the sound effect object. The structural audio labeled text obtained through the above approach comprises indications about how to generate audio for the whole plain text document. An audio generating process may be performed based on the structural audio labeled text so as to generate the audio file 160, wherein the audio generating process may invoke a corresponding voice model for each utterance or descriptive part based on labels in the structural audio labeled text and generate corresponding voices, and may also invoke corresponding background music, sound effects, etc. based on labels in the structural audio labeled text.

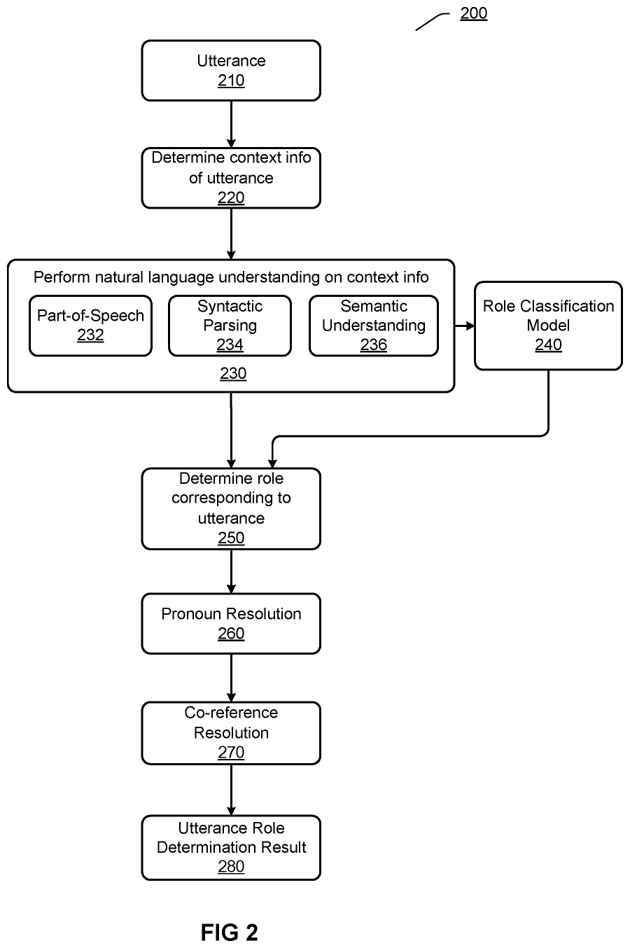

FIG. 2 illustrates an exemplary process 200 for determining a role corresponding to an utterance according to an embodiment. The process 200 may be performed for determining a role for an utterance 210. The utterance 210 may be detected from a plain text document.

At 220, context information of the utterance 210 may be determined. Herein, context information may refer to text content in the document, which is used for determining a role corresponding to the utterance 210. The context information may comprise various types of text content.

In one case, the context information may be the utterance 210 itself. For example, if the utterance 210 is <“I'm Tom, come from Seattle”>, context information may be determined as <I'm Tom, come from Seattle>.

In one case, the context information may be a descriptive part in a sentence including the utterance 210. Herein, a sentence may refer to a collection of a series of words which expresses a full meaning and has punctuation used at a sentence's end.

Usually, sentences may be divided based on full stop, exclamation mark, etc. For example, if the utterance 210 is <“I come from Seattle”>, and a sentence including the utterance 210 is <Tom said “I come from Seattle”.>, then context information may be determined as a descriptive part <Tom said> in the sentence.

In one case, the context information may be at least one another sentence adjacent to the sentence including the utterance 210. Herein, the adjacent at least one another sentence may refer to one or more sentences before the sentence including the utterance 210, one or more sentences after the sentence including the utterance 210, or a combination thereof. Said another sentence may comprise utterances and/or descriptive parts. For example, if the utterance 210 is <“It's beautiful here”> and a sentence including the utterance 210 is the utterance 210 itself, then context information may be determined as another sentence <Tom walked to the river> before the sentence including the utterance 210. Moreover, for example, if the utterance 210 is <“It's beautiful here”> and a sentence including the utterance 210 is the utterance 210 itself, then context information may be determined as another sentence <Tom and Jack walked to the river> before the sentence including the utterance 210 and another sentence <Tom was very excited> after the sentence including the utterance 210.

Only several exemplary cases of context information are listed above, and these cases may also be arbitrarily combined. For example, in one case, context information may be a combination of a sentence including the utterance 210 and at least one another adjacent sentence. For example, if the utterance 210 is <“Jack, look, it's beautiful here”> and a sentence including the utterance 210 is the utterance 210 itself, then context information may be determined as both this sentence including the utterance 210 and another sentence <Tom and Jack walked to the river> before this sentence.

The process 200 may perform natural language understanding on the context information of the utterance 210 at 230, so as to further determine a role corresponding to the utterance 210 at 250. Herein, natural language understanding may generally refer to understanding of sentence format and/or sentence meaning. Through performing the natural language understanding, one or more features of the context information may be obtained.

In an implementation, the natural language understanding may comprise determining part-of-speech 232 of words in the context information. Usually, those words of noun or pronoun part-of-speech are very likely to be roles. For example, if the context information is <Tom is very excited>, then the word <Tom> in the context information may be determined as a noun, further, the word <Tom> of noun part-of-speech may be determined as a role at 250.

In an implementation, the natural language understanding may comprise performing syntactic parsing 234 on sentences in the context information. Usually, a subject of a sentence is very likely to be a role. For example, if the context information is <Tom walked to the river>, then a subject of the context information may be determined as <Tom> through syntactic parsing, further, the subject <Tom> may be determined as a role at 250.

In an implementation, the natural language understanding may comprise performing semantic understanding 236 on the context information. Herein, semantic understanding may refer to understanding of a sentence's meaning based on specific expression patterns or specific words. For example, according to normal language expressions, usually, a word before the word “said” is very likely to be a role. For example, if the context information is <Tom said>, then it may be determined that the context information comprises a word <said> through semantic understanding, further, the word <Tom> before the word <said> may be determined as a role at 250.

It is discussed above that the role corresponding to the utterance 210 may be determined based on part-of-speech, results of syntactic parsing, and results of semantic understanding respectively. However, it should be appreciated that, the role corresponding to the utterance 210 may also be determined through any combinations of part-of-speech, results of syntactic parsing, and results of semantic understanding.

Assuming that context information is <Tom held a basketball and walked to the river>, both the words <Tom> and <basketball> in the context information may be determined as noun through part-of-speech analysis. While <Tom> in the words <Tom> and <basketball> may be further determined as a subject through syntactic parsing, and thus <Tom> may be determined as a role. Moreover, assuming that context information is <Tom said to Jack>, it may be determined through semantic understanding that both <Tom> and <Jack> before or after the word <said> may be a role, however, it may be further determined through syntactic parsing that <Tom> is a subject of the sentence, and thus <Tom> may be determined as a role.

Moreover, optionally, the process 200 may define a role classification model 240. The role classification model 240 may adopt, e.g., Gradient Boosted Decision Tree (GBDT). The establishing of the role classification model 240 may be based at least on one or more features of context information obtained through natural language understanding, e.g., part-of-speech, results of syntactic parsing, results of semantic understanding, etc. Moreover, the role classification model 240 may also be based on various other features. For example, the role classification model 240 may be based on an n-gram feature. For example, the role classification model 240 may be based on a distance feature of a word with respect to the utterance, wherein a word with a closer distance to the utterance has a more possibility to be a role. For example, the role classification model 240 may be based on a language pattern feature, wherein language patterns may be trained previously for determining roles corresponding to utterances under the language patterns. As an example, for a language pattern <A and B, “A, . . . ”>, B may be labeled as a role of the utterance <“A, . . . ”>, and thus, for an input sentence <Tome and Jack walked to the river, “Jack, look, it's beautiful here”>, Tom may be determined as a role of the utterance <“Jack, look, it's beautiful here”>.

In the case that the process 200 uses the role classification model 240, the part-of-speech, the results of syntactic parsing, the results of semantic understanding, etc. obtained through the natural language understanding at 230 may be provided to the role classification model 240, and the role corresponding to the utterance 210 may be determined through the role classification model 240 at 250.

In an implementation, optionally, the process 200 may perform pronoun resolution at 260. As mentioned above, those pronouns, e.g., “he”, “she”, etc. may also be determined as a role. In order to further clarify what roles are specifically referred to by these pronouns, it is needed to perform pronoun resolution on a pronoun which is determined as a role. For example, assuming that an utterance 210 is <“It's beautiful here”> and a sentence including the utterance 210 is <Tome walked to the river, and he said “It's beautiful here”>, then <he> may be determined as a role of the utterance 210 at 250. Since in this sentence, the pronoun <he> refers to Tom, and thus, through pronoun resolution, the role of the utterance 210 may be updated to <Tom>, as a final utterance role determination result 280.

In an implementation, optionally, the process 200 may perform co-reference resolution at 270. In some cases, different expressions may be used for the same role entity in a plain text document. For example, if Tom is a teacher, it is possible to use the name “Tom” to refer to the role entity <Tom> in some sentences of the document, while “teacher” is used for referring to the role entity <Tom> in other sentences. Thus, when <Tom> is determined as a role for an utterance, while <teacher> is determined as a role for another sentence, the role <Tom> and the role <teacher> may be unified, through the co-reference resolution, to the role entity <Tom>, as a final utterance role determination result 280.

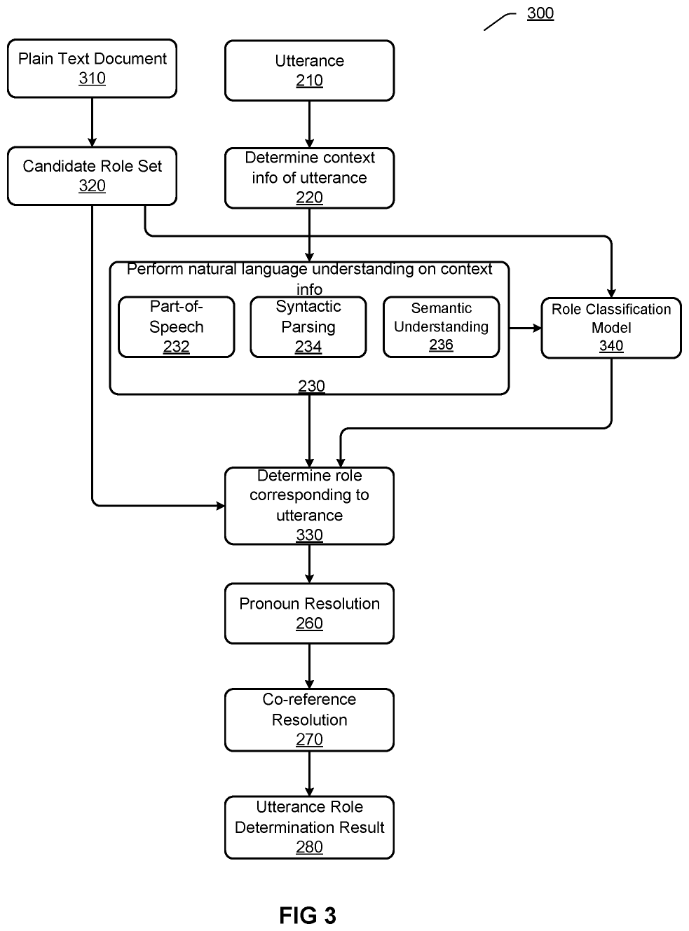

FIG. 3 illustrates another exemplary process 300 for determining a role corresponding to an utterance according to an embodiment. The process 300 is a further variant on the basis of the process 200 in FIG. 2, wherein the process 300 makes an improvement to the operation of determining a role corresponding to an utterance in the process 200, and other operations in the process 300 are the same as the operations in the process 200.

In the process 300, a candidate role set 320 including at least one candidate role may be determined from a plain text document 310. Herein, a candidate role may refer to a word or phrase which is extracted from the plain text document 310 and is possibly as a role of an utterance. Through considering candidate roles from the candidate role set when determining a role corresponding to the utterance 210 at 330, efficiency and accuracy of utterance role determination may be improved.

In an implementation, when determining a role corresponding to the utterance 210 at 330, a candidate role may be selected from the candidate role set 320 as the role corresponding to the utterance 210. For example, assuming that <Tom> is a candidate role in the candidate role set, then when detecting occurrence of the candidate role <Tom> in a sentence <Tom said “It's beautiful here”>, <Tom> may be determined as a role of the utterance <“It's beautiful here”>.

In an implementation, at 330, a combination of the candidate role set 320 and a result from the natural language understanding and/or a result from the role classification model may be considered collectively, so as to determine the role corresponding to the utterance 210. For example, assuming that it is determined, according to the natural language understanding and/or the role classification model, that both <Tom> and <basketball> may be the role corresponding to the utterance 210, then when <Tom> is a candidate role in the candidate role set, <Tom> may be determined as the role of the utterance 210. Moreover, for example, assuming that it is determined, according to the natural language understanding and/or the role classification model, that both <Tom> and <basketball> may be the role corresponding to the utterance 210, then when both <Tom> and <basketball>are candidate roles in the candidate role set, but <Tom> has a higher ranking than <basketball> in the candidate role set, <Tom> may be determined as the role of the utterance 210.

It should be appreciated that, optionally, in an implementation, the candidate role set may also be added as a feature of the role classification model 340. For example, when the role classification model 340 is used for determining a role of an utterance, it may further consider candidate roles in the candidate role set, and give higher weights to roles occurred in the candidate role set and having higher rankings.

There is a plurality of approaches for determining the candidate role set 320 from the plain text document 310.

In an implementation, candidate roles in the candidate role set may be determined through a candidate role classification model. The candidate role classification model may adopt, e.g., GBDT. The candidate role classification model may adopt one or more features, e.g., word frequency, boundary entropy, part-of-speech, etc. Regarding the word frequency feature, statistics about occurrence count/frequency of each word in the document may be made, usually, those words having high word frequency in the document will have a high probability to be candidate roles. Regarding the boundary entropy feature, boundary entropy factors of words may be considered when performing word segmentation on the document. For example, for a phrase “Tom's mother”, through considering boundary entropy, it may be considered whether the phrase “Tom's mother” as a whole is a candidate role, rather than segmenting the phrase into two words “Tom” and “mother” and further determining whether these two words are candidate roles respectively. Regarding the part-of-speech feature, part-of-speech of each word in the document may be determined, usually, noun words or pronoun words have a high probability to be candidate roles.

In an implementation, candidate roles in the candidate role set may be determined based on rules. For example, predetermined language patterns may be used for determining the candidate role set from the document. Herein, the predetermined language patterns may comprise combinations of part-of-speech and/or punctuation. An exemplary predetermined language pattern may be <noun+colon>. Usually, if the word before the colon punctuation is a noun, this noun word has a high probability to be a candidate role. An exemplary predetermined language pattern may be <noun+“and”+noun>. Usually, if two noun words are connected by the conjunction “and”, these two nouns have a high probability to be candidate roles.

In an implementation, candidate roles in the candidate role set may be determined based on a sequence labeling model. The sequence labeling model may be based on, e.g., a Conditional Random Field (CRF) algorithm. The sequence labeling model may adopt one or more features, e.g., key word, a combination of part-of-speech of words, probability distribution of sequence elements, etc. Regarding the key word feature, some key words capable of indicating roles may be trained and obtained previously. For example, the word “said” in <Tom said> is a key word capable of indicating the candidate role <Tom>. Regarding the part-of-speech combination feature, some part-of-speech combination approaches capable of indicating roles may be trained and obtained previously. For example, in a part-of-speech combination approach of <noun+verb>, the noun word has a high probability to be a candidate role. Regarding the feature of probability distribution of sequence elements, the sequence labeling model may perform labeling on each word in an input sequence to obtain a feature representation of the input sequence, and through performing statistical analysis on probability distribution of elements in the feature representation, it may be determined that which word in the input sequence having a certain probability distribution may be a candidate role.

It should be appreciated that the process 300 may determine candidate roles in the candidate role set based on any combinations of the approaches of the candidate role classification model, the predetermined language patterns, and the sequence labeling model. Moreover, optionally, candidate roles determined through one or more approaches may be scored, and only those candidate roles having scores above a predetermined threshold would be added into the candidate role set.

It is discussed above in connection with FIG. 2 and FIG. 3 about how to determine a role corresponding to an utterance. Next, it will be discussed about how to generate voice corresponding to an utterance after determining a role corresponding to the utterance.

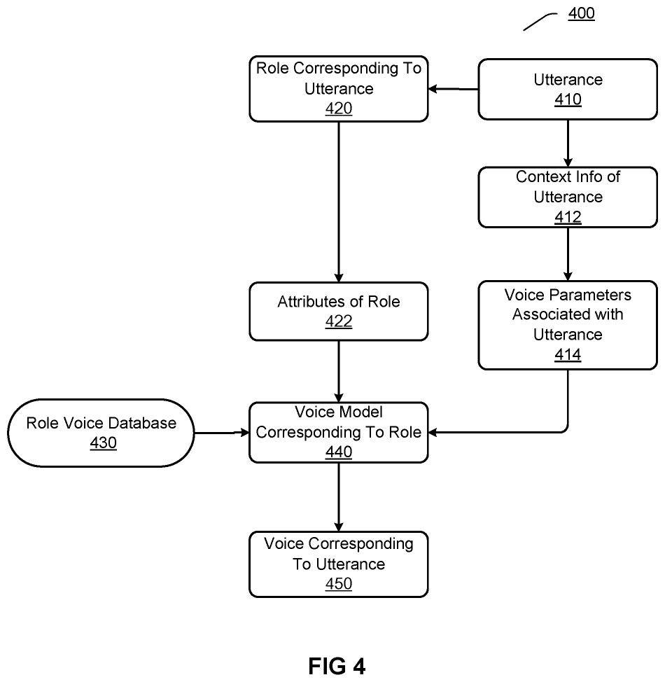

FIG. 4 illustrates an exemplary process 400 for generating voice corresponding to an utterance according to an embodiment. In FIG. 4, a role 420 corresponding to an utterance 410 has been determined for the utterance 410.

The process 400 may further determine attributes 422 of the role 420 corresponding to the utterance 410. Herein, attributes may refer to various types of information for indicating role specific features, e.g., age, gender, profession, character, physical condition, etc. The attributes 422 of the role 420 may be determined through various approaches.

In an approach, the attributes of the role 420 may be determined through an attribute table of a role voice database. As mentioned above, the role voice database may comprise a plurality of candidate voice models, each candidate voice model corresponding to a role. Attributes may be labeled for each role in the role voice database when establishing the role voice database, e.g., age, gender, profession, character, physical condition, etc. of the role may be labeled. The attribute table of the role voice database may be formed by each role and its corresponding attributes in the role voice database. If it is determined, through, e.g., semantic matching, that the role 420 corresponds to a certain role in the attribute table of the role voice database, attributes of the role 420 may be determined as the same as attributes of the certain role.

In an approach, the attributes of the role 420 may be determined through pronoun resolution, wherein a pronoun itself involved in the pronoun resolution may at least indicate gender. As mentioned above, the role 420 may be obtained through the pronoun resolution. For example, assuming that it has been determined that a role corresponding to the utterance 410 <“It's beautiful here”> in a sentence <Tom walked to the river, and he said “It's beautiful here”> is <he>, then the role of the utterance 410 may be updated, through the pronoun resolution, to <Tom>, as the final utterance role determination result 420. Since the pronoun “he” itself indicates the gender “male”, it may be determined that the role <Tom> has an attribute of gender “male”.

In an approach, the attributes of the role 420 may be determined through role address. For example if an address regarding the role <Tom> in the document is <Uncle Tom>, then it may be determined that the gender of the role <Tom> is “male”, and the age is 20-50 years old. For example, if an address regarding the role <Tom> in the document is <teacher Tom>, then it may be determined that the profession of the role <Tom> is “teacher”.

In an approach, the attributes of the role 420 may be determined through role name. For example, if the role 420 is <Tom>, then according to general naming rules, it may be determined that the gender of the role <Tom> is “male”. For example, if the role 420 is <Alice>, then according to general naming rules, it may be determined that the gender of the role <Alice> is “female”.

In an approach, the attributes of the role 420 may be determined through priori role information. Herein, the priori role information may be determined previously from a large amount of other documents through, e.g., Naive Bayesian algorithm, etc., which may comprise a plurality of reference roles occurred in said other documents and their corresponding attributes. An instance of a piece of priori role information may be: <Princess Snow White, gender=female, age=14 years old, profession=princess, character=naive and kind, physical condition=healthy>. For example, if it is determined, through semantic matching, that the role 420 corresponds to <Princess Snow White> in the priori role information, then attributes of the role 420 may be determined as the same as attributes of <Princess Snow White> in the priori role information.

In an approach, the attributes of the role 420 may be determined through role description. Herein, role description may refer to descriptive parts regarding the role 420 and/or utterances involving the role 420 in the document. For example, regarding a role <Tom>, if there is a role description <Tom is a sunny boy, but he had got a cold in these days> in the document, then it may be determined that the role <Tom> has the following attributes: the gender is “male”, the age is below 18 years old, the character is “sunny”, the physical condition is “get a cold”, etc. For example, if a role <Tom> said an utterance <“My wife is very smart”>, then it may be determined that the role <Tom> has the following attributes: the gender is “male”, the age is above 22 years old, etc.

It should be appreciated that only exemplary approaches for determining the attributes 422 of the role 420 are listed above, and these approaches may also be arbitrarily combined to determine the attributes 422 of the role 420. The embodiments of the present disclosure are not limited to any specific approaches or specific combinations of several approaches for determining the attributes 422 of the role 420.

The process 400 may comprise determining a voice model 440 corresponding to the role 420 based on the attributes 422 of the role 420. In an implementation, a specific role which best matches with the attributes 422 may be found in the role voice database 430, through comparing the attributes 422 of the role 420 with the role voice database attribute table of the role voice database 430, and a voice model of the specific role may be determined as the voice model 440 corresponding to the role 420.

The process 400 may generate voice 450 corresponding to the utterance 410 through the voice model 440 corresponding to the role 420. For example, the utterance 410 may be provided as an input to the voice model 440, such that the voice model 440 may further generate the voice 450 corresponding to the utterance 410.

Optionally, the process 400 may further comprise affecting, through voice parameters, the generation of the voice 450 corresponding to the utterance 410 by the voice model 440. Herein, voice parameters may refer to information for indicating characteristics of voice corresponding to the utterance, which may comprise at least one of speaking speed, pitch, volume, emotion, etc. In the process 400, voice parameters 414 associated with the utterance 410 may be determined based on context information 412 of the utterance 410.

In an implementation, the voice parameters, e.g., speaking speed, pitch, volume, etc., may be determined through detecting key words in the context information 412. For example, key words, e.g., “speak rapidly”, “speak patiently”, etc., may indicate that the speaking speed is “fast” or “slow”, key words, e.g., “scream”, “said sadly”, etc., may indicate that the pitch is “high” or “low”, key words, e.g., “shout”, “whisper”, etc., may indicate that the volume is “high” or “low”, and so on. Only some exemplary key words are listed above, and the embodiments of the preset disclosure may also adopt any other appropriate key words.

In an implementation, the voice parameter “emotion” may also be determined through detecting key words in the context information 412. For example, key words, e.g., “angrily said”, etc., may indicate that the emotion is “angry”, key words, e.g., “cheer”, etc., may indicate that the emotion is “happy”, key words, e.g., “get a shock”, etc., may indicate that the emotion is “surprise”, and so on. Moreover, in another implementation, emotion corresponding to the utterance 410 may also be determined through applying an emotion classification model to the utterance 410 itself. The emotion classification model may be trained based on deep learning, which may discriminate any multiple different types of emotions, e.g., happy, angry, sad, surprise, contemptuous, neutral, etc.

The voice parameters 414 determined as mentioned above may be provided to the voice model 440, such that the voice model 440 may consider factors of the voice parameters 414 when generating the voice 450 corresponding to the utterance 410. For example, if the voice parameters 414 indicate “high” volume and “fast” speaking speed, then the voice model 440 may generate the voice 450 corresponding to the utterance 410 in a high-volume and fast approach.

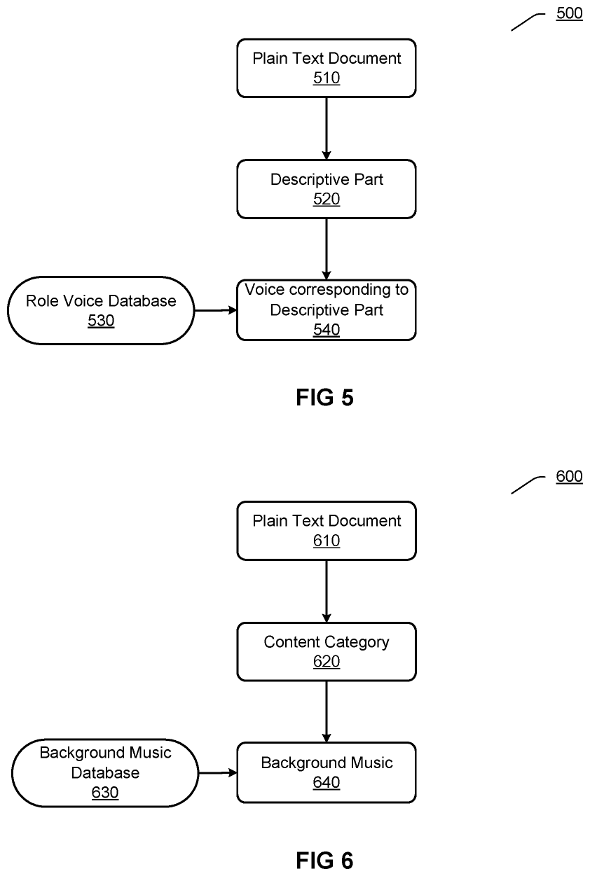

FIG. 5 illustrates an exemplary process 500 for generating voice corresponding to a descriptive part according to an embodiment.

According to the process 500, after a descriptive part 520 is detected from a plain text document 510, voice 540 corresponding to the descriptive part 520 may be generated. Herein, the descriptive part 520 may comprise those parts other than utterances in the document 510. In an approach, a voice model may be selected for the descriptive part 520 from a role voice database 530, and the selected voice model may be used for generating voice for the descriptive part. The voice model may be selected for the descriptive part 520 from the role voice database 530 based on any predetermined rules. The predetermined rules may comprise, e.g., objects oriented by the plain text document, topic category of the plain text document, etc. For example, if the plain text document 510 relates to a fairy tale oriented for children, a voice model of a role easily to be liked by children may be selected for the descriptive part, e.g., a voice model of a young female, a voice model of an old man, etc. For example, if topic category of the plain text document is “popular science”, then a voice model of a middle-aged man whose profession is teacher may be selected for the descriptive part.

FIG. 6 illustrates an exemplary process 600 for determining background music according to an embodiment. The process 600 may add background music according text content of a plain text document 610.

According to the process 600, a content category 620 associated with the whole text content of the plain text document 610 may be determined. The content category 620 may indicate what category the whole text content of the plain text document 610 relates to. For example, the content category 620 may comprise fairy tale, popular science, idiom story, horror, exploration, etc. In an implementation, a tag of the content category 620 may be obtained from the source of the plain text document 610. For example, usually, a source capable of providing a plain text document will provide a tag of a content category associated with the plain text document along with the plain text document. In another implementation, the content category 620 of the plain text document 610 may be determined through a content category classification model established by machine learning.

In the process 600, a background music may be selected from a background music database 630 based on the content category 620 of the plain text document 610. The background music database 630 may comprise various types of background music corresponding to different content categories respectively. For example, for the content category of “fairy tale”, its background music may be a brisk type music, for the content category of “horror”, its background music may be a tense type music, and so on. The background music 640 corresponding to the content category 620 may be found from the background music database 630 through matching the content category 620 of the plain text document 610 with content categories in the background music database 630.

It should be appreciated that, in response to length of an audio file generated for the plain text document, the background music 640 may be cut or replayed based on predetermined rules.

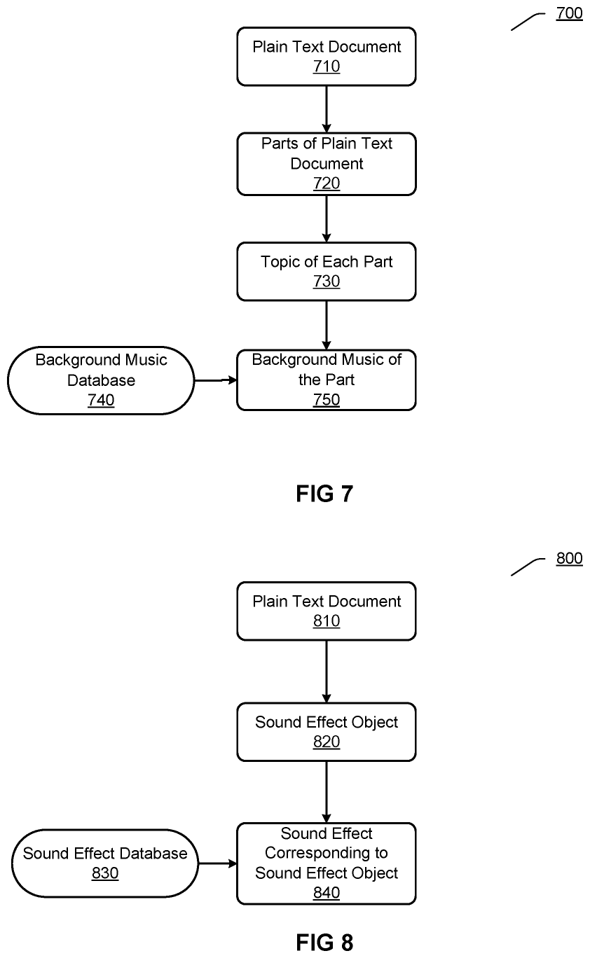

FIG. 7 illustrates another exemplary process 700 for determining background music according to an embodiment. In the process 700, instead of determining background music for the whole plain text document, background music may be determined for a plurality of parts of the plain text document respectively.

According to the process 700, a plain text document 710 may be divided into a plurality of parts 720. In an implementation, a topic classification model established through machine learning may be adopted, and the plain text document 710 may be divided into the plurality of parts 720 according to different topics. The topic classification model may be trained for, with respect to a group of sentences, obtaining a topic associated with the group of sentences. Through applying the topic classification model to the plain text document 710, text content of the plain text document 710 may be divided into a plurality of parts, e.g., several groups of sentences, each group of sentences being associated with a respective topic. Accordingly, a plurality of topics may be obtained from the plain text document 710, wherein the plurality of topics may reflect, e.g., evolving plots. For example, the following topics may be obtained respectively for a plurality of parts in the plain text document 710: Tom played football, Tom came to the river to take a walk, Tom went back home to have a rest, and so on.

According to the process 700, based on a topic 730 of each part of the plain text document 700, background music of this part may be selected from a background music database 740. The background music database 730 may comprise various types of background music corresponding to different topics respectively. For example, for a topic of “football”, its background music may be a fast rhythm music, for a topic of “take a walk”, its background music may be a soothing music, and so on. The background music 750 corresponding to the topic 730 may be found from the background music database 740 through matching the topic 730 with topics in the background music database 740.

Through the process 700, an audio file generated for a plain text document will comprise background music changed according to, e.g., story plots.

FIG. 8 illustrates an exemplary process 800 for determining a sound effect according to an embodiment.

According to the process 800, a sound effect object 820 may be detected from a plain text document 810. A sound effect object may refer to a word in a document that is suitable for adding a sound effect, e.g., an onomatopoetic word, a scenario word, an action word, etc. The onomatopoetic word refers to a word imitating sound, e.g., “ding-dong”, “flip-flop”, etc. The scenario word refers to a word describing a scenario, e.g., “river”, “road”, etc. The action word refers to a word describing an action, e.g., “ring the doorbell”, “clap”, etc. The sound effect object 820 may be detected from the plain text document 810 through text matching, etc.

According to the process 800, a sound effect 840 corresponding to the sound effect object 820 may be selected from a sound effect database 830 based on the sound effect object 820. The sound effect database 830 may comprise a plurality of sound effects corresponding to different sound effect objects respectively. For example, for the onomatopoetic word “ding-dong”, its sound effect may be a recorded actual doorbell sound, for the scenario word “river”, its sound effect may be a sound of running water, for the action word “ring the doorbell”, its sound effect may be a doorbell sound, and so on. The sound effect 840 corresponding to the sound effect object 820 may be found from the sound effect database 830 through matching the sound effect object 820 with sound effect objects in the sound effect database 830 based on, e.g., information retrieval technique.

In an audio file generated for a plain text document, timing or positions for adding sound effects may be set. In an implementation, a sound effect corresponding to a sound effect object may be played at the same time that voice corresponding to the sound effect object occurs. For example, for the sound effect object “ding-dong”, a doorbell sound corresponding to the sound effect object may be played at the meantime the “ding-dong” is spoken in voice. In an implementation, a sound effect corresponding to a sound effect object may be played before voice corresponding to the sound effect object or voice corresponding to a sentence including the sound effect object occurs. For example, a sound effect object “ring the doorbell” is included in a sentence <Tom rang the doorbell>, thus a doorbell sound corresponding to the sound effect object may be displayed firstly, and then “Tom rang the doorbell” is spoken in voice. In an implementation, a sound effect corresponding to a sound effect object may be played after voice corresponding to the sound effect object or voice corresponding to a sentence including the sound effect object occurs. For example, a sound effect object “river” is included in a sentence <Tom walked to the river>, thus “Tom walked to the river” may be spoken in voice firstly, and then a running water sound corresponding to the sound effect object may be displayed.

In an audio file generated for a plain text document, durations of sound effects may be set. In an implementation, duration of a sound effect corresponding to a sound effect object may be equal to or approximate to duration of voice corresponding to the sound effect object. For example, assuming that duration of voice corresponding to the sound effect object “ding-dong” is 0.9 second, then duration for playing a doorbell sound corresponding to the sound effect object may also be 0.9 second or close to 0.9 second. In an implementation, duration of a sound effect corresponding to a sound effect object may be obviously shorter than duration of voice corresponding to the sound effect object. For example, assuming that duration of voice corresponding to the sound effect object “clap” is 0.8 second, then duration for playing a clapping sound corresponding to the sound effect object may be only 0.3 second. In an implementation, duration of a sound effect corresponding to a sound effect object may be obviously longer than duration of voice corresponding to the sound effect object. For example, assuming that duration of voice corresponding to the sound effect object “river” is 0.8 second, then duration for playing a running water sound corresponding to the sound effect object may exceed 3 seconds. It should be appreciated that the above are only examples of setting durations of sound effects, and actually, the durations of sound effects may be set according to any predetermined rules or according to any priori knowledge. For example, a sound of thunder may usually last for several seconds, thus, for the sound effect object “thunder”, duration of sound of thunder corresponding to the sound effect object may be empirically set as several seconds.

Moreover, in an audio file generated for a plain text document, various play modes may be set for sound effects, including high volume mode, low volume mode, gradual change mode, fade-in fade-out mode, etc. For example, for the sound effect object “road”, car sounds corresponding to the sound effect object may be played in a high volume, while for the sound effect object “river”, running water sound corresponding to the sound effect object may be played in a low volume. For example, for the sound effect object “thunder”, a low volume may be adopted at the beginning of playing sound of thunder corresponding to the sound effect object, then the volume is gradually increased, and the volume is decreased again at the end of playing the sound of thunder.

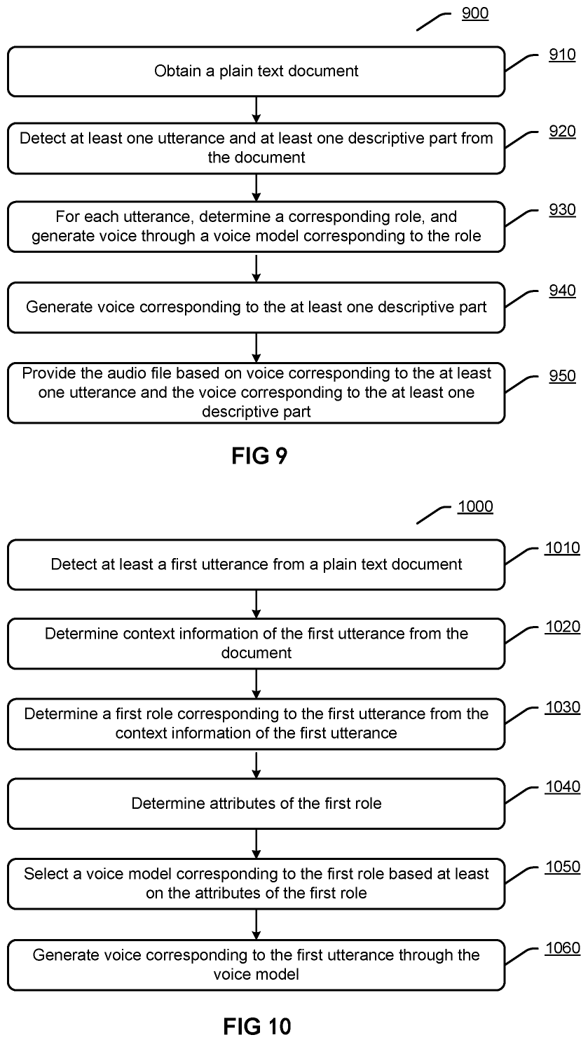

FIG. 9 illustrates a flowchart of an exemplary method 900 for providing an audio file based on a plain text document according to an embodiment.

At 910, a plain text document may be obtained.

At 920, at least one utterance and at least one descriptive part may be detected from the document.

At 930, for each utterance in the at least one utterance, a role corresponding to the utterance may be determined, and voice corresponding to the utterance may be generated through a voice model corresponding to the role.

At 940, voice corresponding to the at least one descriptive part may be generated.

At 950, the audio file may be provided based on voice corresponding to the at least one utterance and the voice corresponding to the at least one descriptive part.

In an implementation, the method 900 may further comprise: determining a content category of the document or a topic of at least one part in the document; and adding a background music corresponding to the document or the at least one part to the audio file based on the content category or the topic.

In an implementation, the method 900 may further comprise: detecting at least one sound effect object from the document, the at least one sound effect object comprising an onomatopoetic word, a scenario word or an action word; and adding a sound effect corresponding to the sound effect object to the audio file.

It should be appreciated that the method 900 may further comprise any steps/processes for providing an audio file based on a plain text document according to the embodiments of the present disclosure as mentioned above.

FIG. 10 illustrates a flowchart of an exemplary method 1000 for generating audio for a plain text document according to an embodiment.

At 1010, at least a first utterance may be detected from a plain text document.

At 1020, context information of the first utterance may be determined from the document.

At 1030, a first role corresponding to the first utterance may be determined from the context information of the first utterance.

At 1040, attributes of the first role may be determined.

At 1050, a voice model corresponding to the first role may be selected based at least on the attributes of the first role.

At 1060, voice corresponding to the first utterance may be generated through the voice model.

In an implementation, the context information of the first utterance may comprise at least one of: the first utterance; a first descriptive part in a first sentence including the first utterance; and at least a second sentence adjacent to the first sentence including the first utterance.

In an implementation, the determining the first role corresponding to the first utterance may comprise: performing natural language understanding on the context information of the first utterance to obtain at least one feature of the following features: part-of-speech of words in the context information, results of syntactic parsing on the context information, and results of semantic understanding on the context information; and identifying the first role based on the at least one feature.

In an implementation, the determining the first role corresponding to the first utterance may comprise: performing natural language understanding on the context information of the first utterance to obtain at least one feature of the following features: part-of-speech of words in the context information, results of syntactic parsing on the context information, and results of semantic understanding on the context information; providing the at least one feature to a role classification model; and determining the first role through the role classification model.

In an implementation, the method 1000 may further comprise: determining at least one candidate role from the document. The determining the first role corresponding to the first utterance may comprise: selecting the first role from the at least one candidate role. The at least one candidate role may be determined based on at least one of: a candidate role classification model, predetermined language patterns, and a sequence labeling model. The candidate role classification model may adopt at least one feature of the following features: word frequency, boundary entropy, and part-of-speech. The predetermined language patterns may comprise combinations of part-of-speech and/or punctuation. The sequence labeling model may adopt at least one feature of the following features: key word, a combination of part-of-speech of words, and probability distribution of sequence elements.

In an implementation, the method 1000 may further comprise: determining that part-of-speech of the first role is a pronoun; and performing pronoun resolution on the first role.

In an implementation, the method 1000 may further comprise: detecting at least a second utterance from the document; determining context information of the second utterance from the document; determining a second role corresponding to the second utterance from the context information of the second utterance; determining that the second role corresponds to the first role; and performing co-reference resolution on the first role and the second role.

In an implementation, the attributes of the first role may comprise at least one of age, gender, profession, character and physical condition. The determining the attributes of the first role may comprise: determining the attributes of the first role according to at least one of an attribute table of a role voice database, pronoun resolution, role address, role name, priori role information, and role description.

In an implementation, the generating the voice corresponding to the first utterance may comprise: determining at least one voice parameter associated with the first utterance based on the context information of the first utterance, the at least one voice parameter comprising at least one of speaking speed, pitch, volume and emotion; and generating the voice corresponding to the first utterance through applying the at least one voice parameter to the voice model. The emotion may be determined based on key words in the context information of the first utterance and/or based on an emotion classification model.

In an implementation, the method 1000 may further comprise: determining a content category of the document; and selecting a background music based on the content category.

In an implementation, the method 1000 may further comprise: determining a topic of a first part in the document; and selecting a background music for the first part based on the topic.

In an implementation, the method 1000 may further comprise: detecting at least one sound effect object from the document, the at least one sound effect object comprising an onomatopoetic word, a scenario word or an action word; and selecting a corresponding sound effect for the sound effect object.

In an implementation, the method 1000 may further comprise: detecting at least one descriptive part from the document based on key words and/or key punctuations; and generating voice corresponding to the at least one descriptive part.

It should be appreciated that the method 1000 may further comprise any steps/processes for generating audio for a plain text document according to the embodiments of the present disclosure as mentioned above.

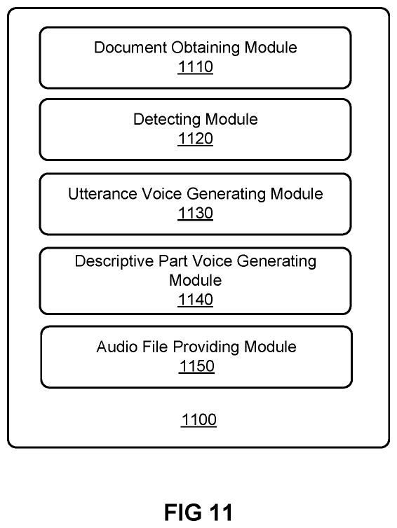

FIG. 11 illustrates an exemplary apparatus 1100 for providing an audio file based on a plain text document according to an embodiment.

The apparatus 1100 may comprise: a document obtaining module 1110, for obtaining a plain text document; a detecting module 1120, for detecting at least one utterance and at least one descriptive part from the document; an utterance voice generating module 1130, for, for each utterance in the at least one utterance, determining a role corresponding to the utterance, and generating voice corresponding to the utterance through a voice model corresponding to the role; a descriptive part voice generating module 1140, for generating voice corresponding to the at least one descriptive part; and an audio file providing module 1150, for providing the audio file based on voice corresponding to the at least one utterance and the voice corresponding to the at least one descriptive part.

Moreover, the apparatus 1100 may also comprise any other modules configured for providing an audio file based on a plain text document according to the embodiments of the present disclosure as mentioned above.

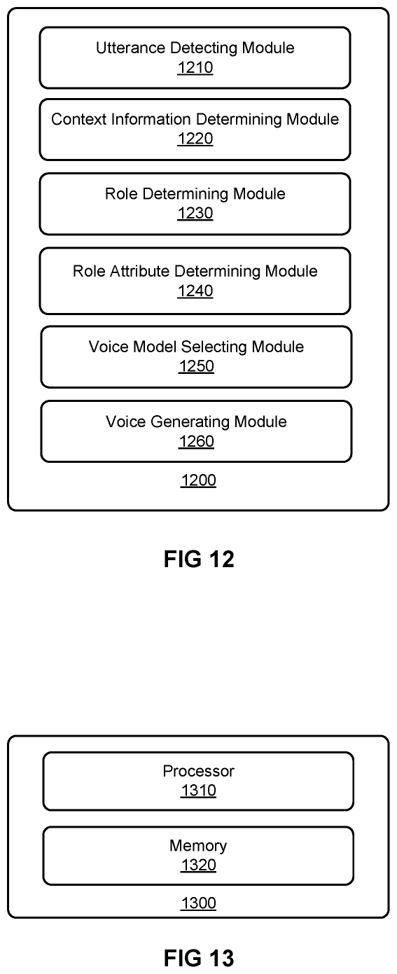

FIG. 12 illustrates an exemplary apparatus 1200 for generating audio for a plain text document according to an embodiment.

The apparatus 1200 may comprise: an utterance detecting module 1210, for detecting at least a first utterance from the document; a context information determining module 1220, for determining context information of the first utterance from the document; a role determining module 1230, for determining a first role corresponding to the first utterance from the context information of the first utterance; a role attribute determining module 1240, for determining attributes of the first role; a voice model selecting module 1250, for selecting a voice model corresponding to the first role based at least on the attributes of the first role; and a voice generating module 1260, for generating voice corresponding to the first utterance through the voice model.

Moreover, the apparatus 1200 may also comprise any other modules configured for generating audio for a plain text document according to the embodiments of the present disclosure as mentioned above.

FIG. 13 illustrates an exemplary apparatus 1300 for generating audio for a plain text document according to an embodiment.

The apparatus 1300 may comprise at least one processor 1310. The apparatus 1300 may further comprise a memory 1320 connected to the processor 1310. The memory 1320 may store computer-executable instructions that when executed, cause the processor 1310 to perform any operations of the methods for generating audio for a plain text document and the methods for providing an audio file based on a plain text document according to the embodiments of the present disclosure as mentioned above.

The embodiments of the present disclosure may be embodied in a non-transitory computer-readable medium. The non-transitory computer-readable medium may comprise instructions that, when executed, cause one or more processors to perform any operations of the methods for generating audio for a plain text document and the methods for providing an audio file based on a plain text document according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein by reference and are intended to be encompassed by the claims.

1. A method for generating audio for a plain text document, comprising:
detecting at least a first utterance from the document;
determining context information of the first utterance from the document;
determining a first role corresponding to the first utterance from the context information of the first utterance;
determining attributes of the first role;
selecting a voice model corresponding to the first role based at least on the attributes of the first role; and
generating voice corresponding to the first utterance through the voice model.

2. The method of claim 1, wherein the context information of the first utterance comprises at least one of:
the first utterance;
a first descriptive part in a first sentence including the first utterance; and
at least a second sentence adjacent to the first sentence including the first utterance.

3. The method of claim 1, wherein the determining the first role corresponding to the first utterance comprises:
performing natural language understanding on the context information of the first utterance to obtain at least one feature of the following features: part-of-speech of words in the context information, results of syntactic parsing on the context information, and results of semantic understanding on the context information; and
identifying the first role based on the at least one feature.

4. The method of claim 1, wherein the determining the first role corresponding to the first utterance comprises:
performing natural language understanding on the context information of the first utterance to obtain at least one feature of the following features: part-of-speech of words in the context information, results of syntactic parsing on the context information, and results of semantic understanding on the context information;
providing the at least one feature to a role classification model; and
determining the first role through the role classification model.

5. The method of claim 1, further comprising:
determining at least one candidate role from the document,
wherein the determining the first role corresponding to the first utterance comprises: selecting the first role from the at least one candidate role.

6. The method of claim 5, wherein
the at least one candidate role is determined based on at least one of: a candidate role classification model, predetermined language patterns, and a sequence labeling model,
the candidate role classification model adopts at least one feature of the following features: word frequency, boundary entropy, and part-of-speech,
the predetermined language patterns comprise combinations of part-of-speech and/or punctuation, and
the sequence labeling model adopts at least one feature of the following features: key word, a combination of part-of-speech of words, and probability distribution of sequence elements.

7. The method of claim 1, further comprising:
determining that part-of-speech of the first role is a pronoun; and
performing pronoun resolution on the first role.

8. The method of claim 1, further comprising:
detecting at least a second utterance from the document;
determining context information of the second utterance from the document;
determining a second role corresponding to the second utterance from the context information of the second utterance;
determining that the second role corresponds to the first role; and
performing co-reference resolution on the first role and the second role.

9. The method of claim 1, wherein the attributes of the first role comprise at least one of age, gender, profession, character and physical condition, and the determining the attributes of the first role comprises:
determining the attributes of the first role according to at least one of: an attribute table of a role voice database, pronoun resolution, role address, role name, priori role information, and role description.

10. The method of claim 1, wherein the generating the voice corresponding to the first utterance comprises:
determining at least one voice parameter associated with the first utterance based on the context information of the first utterance, the at least one voice parameter comprising at least one of speaking speed, pitch, volume and emotion; and
generating the voice corresponding to the first utterance through applying the at least one voice parameter to the voice model.

11. The method of claim 1, further comprising at least one of:
determining a content category of the document and selecting a background music based on the content category; or
determining a topic of a first part in the document and selecting a background music for the first part based on the topic.

12. The method of claim 1, further comprising:
detecting at least one sound effect object from the document, the at least one sound effect object comprising an onomatopoetic word, a scenario word or an action word; and
selecting a corresponding sound effect for the sound effect object.

13. A method for providing an audio file based on a plain text document, comprising:
obtaining the document;
detecting at least one utterance and at least one descriptive part from the document;
for each utterance in the at least one utterance:
determining a role corresponding to the utterance, and
generating voice corresponding to the utterance through a voice model corresponding to the role; and
generating voice corresponding to the at least one descriptive part; and
providing the audio file based on voice corresponding to the at least one utterance and the voice corresponding to the at least one descriptive part.

14. An apparatus for generating audio for a plain text document, comprising:
an utterance detecting module, for detecting at least a first utterance from the document;
a context information determining module, for determining context information of the first utterance from the document;
a role determining module, for determining a first role corresponding to the first utterance from the context information of the first utterance;
a role attribute determining module, for determining attributes of the first role;
a voice model selecting module, for selecting a voice model corresponding to the first role based at least on the attributes of the first role; and
a voice generating module, for generating voice corresponding to the first utterance through the voice model.

15. An apparatus for generating audio for a plain text document, comprising:
at least one processor; and
a memory storing computer-executable instructions that, when executed, cause the processor to:
detect at least a first utterance from the document;
determine context information of the first utterance from the document;
determine a first role corresponding to the first utterance from the context information of the first utterance;
determine attributes of the first role;
select a voice model corresponding to the first role based at least on the attributes of the first role; and
generate voice corresponding to the first utterance through the voice model.
